(19) United States
(12) Patent Application Publication
(10) Pub. No.: US 2003/0026428 A1
(43) Pub. Date: Feb. 6, 2003

(54) Method of transmitting confidential data

(76) Inventor: Yann Loisel, La Ciotat (FR)

Correspondence Address: Finnegan, Henderson, Farabow,, Garrett & Dunner, L.L.P., 1300 I Street, N.W., Washington, DC, 20005-3315, US

(21) Appl. No.: 10/206,212

(22) Filed: Jul. 29, 2002

(30) Foreign Application Priority Data
Jul. 30, 2001 (DE) 101 37 152.7

(51) Int. Cl. H04L 9/00

(52) U.S. Cl. 380/277

(57) ABSTRACT

For transmitting confidential data, two devices (D1, D2) are linked through a transmission channel which is secured by symmetric encryption with a shared secret session key. Both devices (D1, D2) possess the same secret session key (K) which is developed from two random keys (K1, K2) each of which is generated in a different one of the devices Both random keys are exchanged between the devices (D1, D2) using asymmetric encryption

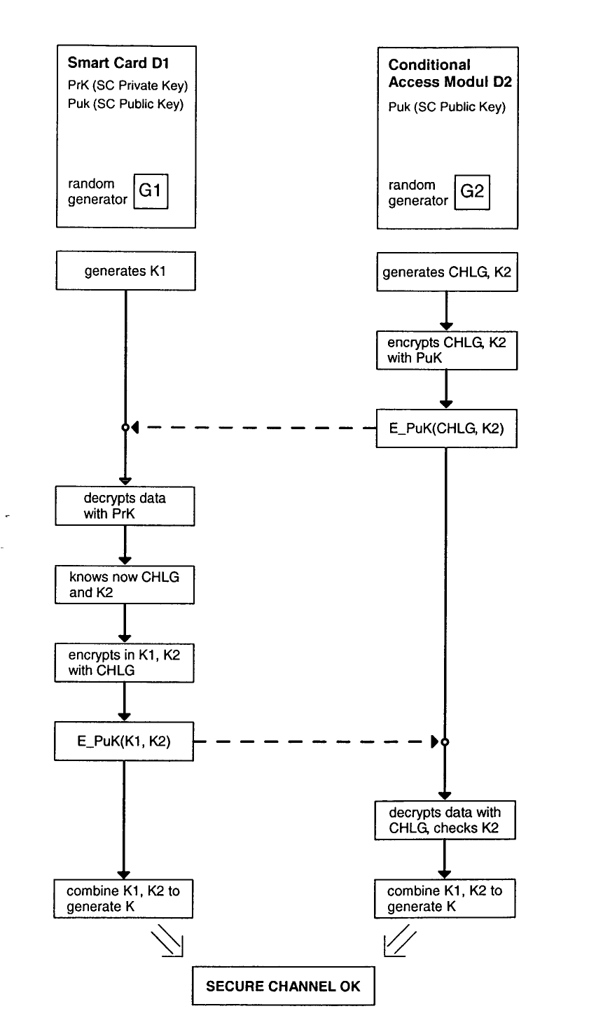

### FIELD OF THE INVENTION

The present invention relates to a method of transmitting confidential data between two communication devices and, in particular, to a method of secure communication between a chipcard and a conditional access module (CAM) in a pay TV environment.

### BACKGROUND OF THE INVENTION

EP 0 720 326 A2 discloses a method of establishing a secure communication channel between two similar stations The communication procedure uses symmetric encryption/decryption one to avoid problems encountered with earlier systems where a distributed master key is used in conjunction with modifier elements such as a time stamp, a counter or the like In the symmetric procedure, a secret encryption key is known to both communication devices. This method only works with paired communication devices.

In another method that is disclosed in WO 97/38530, a secure communication between two devices such as a CAM and a chipcard is obtained by asymmetric encryption. One of the devices generates a random key which is encrypted with a public key and sent to the second device. The second device decrypts the encrypted key with a corresponding private key. Both devices use the random key for encryption and decryption of data exchanged between the devices This method relies on a random value generated in only one of the devices

### SUMMARY OF THE INVENTION

The present invention provides a secure method of transmitting data between two communication devices which relies on a common secret based on two values each of which is generated by a different one of the devices, thereby avoiding possible replay attacks. According to the invention, the method of transmitting data between two communication devices includes the following steps

Step 1: a first random key is generated on the side of the first communication device.

Step 2 a second random key is generated on the side of the second communication device

Step 3: the second random key is encrypted by means of a public key and transmitted to the first communication device

Step 4 on the side of the first communication device, the transmitted second random key is decrypted with a corresponding private key

Step 5: the first random key is encrypted on the side of the first communication device and transmitted to the second communication device

Step 6 the second communication device decrypts the transmitted first random key.

Step 7. each communication device combines the random keys into a secret session key used for encryption and decryption of the data transmitted between the devices.

After step 7, both devices share a secret session key based on two random values generated independently of each other and in different devices, thereby excluding the possibility of a successful replay attack.

A further improvement of the method is achieved by using a particular encryption key for encryption of the first random key in steps 5 and 6: in addition to the second random key, a random number (a “challenge”) is generated on the side of the second communication device, and this random number is likewise encrypted with the public key and transferred to the first communication device The first communication device decrypts the random number with its private key, and the first random key is encrypted with the decrypted random number prior to the transmission of the first random key to the second communication device.

### SHORT DESCRIPTION OF DRAWINGS

A preferred embodiment of the invention will now be disclosed with reference to the drawing. The single FIGURE of the drawing illustrates essential steps of the preferred embodiment.

### DETAILED DESCRIPTION OF EMBODIMENT

With reference to the drawing, a first communication device D1 is a Smart Card (SC) and a second communication device D2 is a conditional access module (CAM) in a digital pay TV environment (DVB, for example), although the invention is not limited to application in such an environment Both devices D1 and D2 would exchange confidential data, such as entitlement management messages (EMMs), entitlement control messages (ECMs) and control words (CWs). To protect the confidential data from eavesdropping, a secure communication channel is established between the devices D1, D2

The first device D1 owns a secret private key PrK and has a corresponding public key PuK. Device D1 also has a random number generator G1

The second device D2 knows the public key PuK, which may have been received from device D1 in the clear Device D2 also has a random number generator, G2.

Initially, both devices D1, D2 do not share any secret In order to provide a secret session key shared by the devices and used for encryption/decryption of data exchanged between the devices, a protocol is proposed that is safe enough to avoid leakage of information, and powerful enough to exchange keys of a sufficient length. The protocol involves asymmetric cryptography for transmission both from D1 to D2 and from D2 to D1

Random number generator G1 in device D1 internally generates a first random number K1 Random number generator G2 in device D2 internally generates a second random number K2 D2 will also generate a further random value, a “challenge” CHLG. Random numbers K1 and K2 are of a sufficient length to avoid crypto-analytic brute-force attack

Device D2 encrypts K2 and CHLG with public key PuK and sends the result to device D1. Device D1 will receive the result and decrypt it with its private key PrK. Device D1 now knows K2 and CHLG. Device D1 concatenates K2 with its own random number K1 and encrypts the concatenated numbers with CHLG The encrypted result is sent from D1 to D2

Device D2 now decrypts the received result to K1 and K2 using CHLG as the decryption key to retrieve K1 and K2 D2 checks for consistency of received K2 with its own K2 If the correct K2 has been received, both devices D1 and D2 now share both random numbers K1 and K2

Finally, both devices D1 and D2 will combine random keys K1 and K2 in the same manner to provide a secret session key K now owned by both devices Session key K is used for symmetric encryption and decryption of confidential data exchanged between the devices.

Another example for use of the invention is a conditional access module (CAM) as the first device D1 and a decoder in a Set-Top-Box (STB) as the second device D2. Here, too, confidential data would be exchanged using a session key for encryption/decryption that originates from two random numbers each generated in a different one of the devices.

1. A method of transmitting confidential data between two communication devices, in which
a) a first random key (K1) is generated on the side of the first communication device (D1);
b) a second random key (K2) is generated on the side of the second communication device (D2),
c) the second random key (K2) is encrypted by means of a public key (PuK) and transmitted from the second (D2) to the first (D1) communication device;
d) on the side of the first communication device (D1), the transmitted second random key (K2) is decrypted using a corresponding private key (PrK),
e) the first random key (K1) is encrypted oil the side of the first communication device (D1) and transmitted to the second communication device (D2),
f) the first communication device (D1) decrypts the transmitted first random key (K1); and
g) both communication devices (1, 2) combine the random keys (K1, K2) to a secret session key (K) used by each device (D1, D2) for symmetric encryption and decryption of the confidential data

2. The method according to claim 1, in which
h) in addition to the second random key (K(2), a random number (CHLG) is generated on the side of the second communication device (D2),
i) the random number (CHLG) is likewise encrypted by means of the public key (PuK) and transferred to the first communication device (D1);
j) the random number (CHLG) is decrypted by the first communication device (D1) using its private key (PrK),
k) the first random key (K1) is encrypted with the random number (CHLG) prior to being transmitted to the second communication device (D2)

3. The method according to claim 2, in which
l) the first communication device (D1) encrypts the second random key (K2) and transmits it to the second communication device (D2),
m) the second communication device (D2) decrypts the transmitted second random key (K2) and checks its integrity by comparison with the original second random number (K2)

4. The method according to claim 2, in which
n) the first communication device (D1) decrypts the second random key (K2) using the random number (CHLG) and transmits it to the second communication device (D2),
o) the second communication device (D2) decrypts the transmitted second random key (K2) using the random number (CHLG) and checks its integrity by comparison with the original second random key (K2)

5. The method according to claim 1, in which the session key (K) is developed so as to have the same length as each of the first and second random keys (K1, K2).

6. The method according to claim 1, in which the first and second random keys (K1, K2) are each produced by a respective random number generator G1, G2) of the first and second communication device (D1, D2)

7. The method according to claim 1, in which the first communication device (D1) is a smart card and the second communication device (D2) is a conditional access module (CAM).

8. The method according to claim 1, in which the first communication device (D1) is a conditional access module (CAM) and the second communication device (D2) is a decoder in a Set-Top-Box (STB)
